(19) United States
(12) Patent Application Publication
(10) Pub. No.: US 2013/0093984 A1
(43) Pub. Date: Apr. 18, 2013

(54) LCD Panel

(71) Applicant: Hung-Lung Hou, Shenzhen (CN)

(72) Inventor: Hung-Lung Hou, Shenzhen (CN)

(73) Assignee: SHENZHEN CHINA STAR OPTOELECTRONICS TECHNOLOGY CO., LTD., Shenzhen (CN)

(21) Appl. No.: 13/376,596

(22) PCT Filed: Oct. 13, 2011
(86) PCT No.: PCT/CN11/80727

§ 371 Date: Dec. 7, 2011

(30) Foreign Application Priority Data
Oct. 12, 2011 (CN) 201110308486.1

(51) Int. Cl. G02F 1/1335

(52) U.S. Cl. 349/106

(57) ABSTRACT

The present invention discloses an LCD panel, which includes an upper substrate, a lower substrate, a liquid crystal layer, a color resist layer and a plurality of pixel electrodes. The color resist layer is disposed on the lower substrate. The pixel electrodes are respectively disposed in pixel units and located on the color resist layer. Projected areas of the pixel electrodes partially overlap the gate lines, and the projected areas of the pixel electrodes successively increase with a direction. The pixel electrode of the present invention compensates differences of feed-through voltage on various regions of the panel, thereby solving a crosstalk problem.

### FIELD OF THE INVENTION

The present invention relates to a liquid crystal display (LCD), and more particularly to an LCD panel.

### BACKGROUND OF THE INVENTION

Referring to FIG. 1, FIG. 1 is a driving circuit diagram illustrating a liquid crystal display (LCD) panel in prior art. The LCD panel includes pixel electrodes 101, gate lines 102, data lines 103, liquid crystal capacitors 104, and storage capacitors 105.

After a gate voltage (not shown) of a thin film transistor (TFT) is turned on, an electrical signal is written into the pixel electrode 101 via the data line 103, thereby providing a filling voltage signal for the pixel electrode 101. Then, the gate voltage of the TFT is turned off, and the pixel electrode 101 maintains a constant voltage.

Referring to FIG. 2, FIG. 2 is a schematic drawing illustrating a waveform of a driving signal in the prior art. In driving the TFT, the gate voltage 210 becomes a high level, and the pixel electrode 101 begins to be charged with the voltage signal 220 of the data line 103. However, when the gate voltage of the TFT is turned off, the voltage of the pixel electrode 101 is affected by the capacitors and generates a feed-through voltage ΔV due to a redistribution of electric charges. The feed-through voltage ΔV can be expressed according to a formula listed below. ΔV=(Cgs/(Clc+Cs+Cgs))×Vpp, in which Cgs is a coupling capacitor between the gate and the pixel electrode 101, Clc is the liquid crystal capacitor 104, Cs is a storage capacitor 105, and Vpp is a voltage difference of the gate voltage 210. As a result, a central level 250 of positive and negative polarities of the gate voltage 210 needs to be raised.

Referring to FIG. 3, FIG. 3 is a schematic drawing illustrating waveforms of the gate voltage 210 respectively at right and left sides of the LCD panel. Various resistance and capacitance (RC) delays affect each Vpp of pixels at the gate line 102, such that the waveform of the gate voltage 210 closer to a driver chip (usually at the left) is more square, and the waveform of the gate voltage 21 away from the driver chip is distorted. Thus, it can be seen from the formula of the feed-through voltage that the Vpp located on the left side of the panel is larger, which making the feed-through voltage ΔV bigger and the central level 250 of the positive and negative polarities lower. The Vpp located on the right side of the panel is smaller, which makes the feed-through voltage ΔV smaller and makes the central level 250 of the positive and negative polarities higher.

The feed-through voltage ΔV makes voltages of the positive and negative polarities, which originally were symmetrical with respect to the Vcom, asymmetrical. The voltage differences generate a flicker when driving the panel by using the voltages of the positive and negative polarities, resulting in a crosstalk.

Therefore, there is a problem of the crosstalk resulting form the asymmetrical positive and negative voltages when the gate voltage of the TFT is turned off and the voltage of the pixel electrode jumps. The problem remains to be solved in the LCD technology.

### SUMMARY OF THE INVENTION

An objective of the present invention is to provide an LCD panel which can solve the problem of the crosstalk resulting form the nonsymmetrical positive and negative voltages when the gate voltage of the TFT is turned off and the voltage of the pixel electrode jumps.

To achieve the foregoing objective, the technical solution of this invention is implemented as follows. An LCD panel, which includes an upper substrate, a lower substrate, and a liquid crystal layer located between the upper substrate and the lower substrate. The lower substrate includes a plurality of gate lines and data lines which define a plurality of pixel units. Each of the pixel units includes a TFT. The LCD panel further includes a color resist layer and a plurality of pixel electrodes. The color resist layer is disposed on the lower substrate and covers the TFT in each pixel unit. The pixel electrodes are respectively disposed in the pixel units and located on the color resist layer. Projected areas of the pixel electrodes partially overlap the gate lines, and the projected areas of the pixel electrodes successively increase with a direction.

Preferably, the direction of increasing is a direction of the gate line, and especially a scanning direction of the gate line.

In one preferred embodiment, the overlapped areas of the pixel electrodes overlapping the gate lines successively increase with a direction. Preferably, the direction of increasing is a scanning direction of the gate line.

To achieve the foregoing objective, an LCD panel further provided in the present invention includes an upper substrate, a lower substrate, and a liquid crystal layer located between the upper substrate and the lower substrate. The lower substrate includes a plurality of gate lines and data lines which define a plurality of pixel units. Each of the pixel units includes a TFT. The LCD panel further includes a color resist layer and a plurality of pixel electrodes. The color resist layer is disposed on the lower substrate and covers the TFT in each pixel unit. The pixel electrodes are respectively disposed in the pixel units and located on the color resist layer. Projected areas of the pixel electrodes partially overlap the data lines, and the projected areas of the pixel electrodes successively decrease with a direction.

Preferably, the direction of decreasing is a direction of the data line, and especially a transmitting direction of the data line.

In one preferred embodiment, the overlapped areas of the pixel electrodes overlapping the data lines successively decrease with a direction. Preferably, the direction of decreasing is a transmitting direction of the data line.

In comparison with the prior art, the color resist layer of the LCD panel of the present invention is disposed on the lower substrate (i.e., Color filter On Array, COA), so that the projected areas of the pixel electrodes on the pixel unit can overlap the gate lines and the data lines. Thus, a larger aperture ratio can be reached. In addition, the areas of the pixel electrodes of the present invention are designed to successively decrease with the directions of gate line or the data line. The successively decreased areas of the pixel electrodes reduce the corresponding coupling capacitors, thereby compensating the differences of the feed-through voltage ΔV caused by the RC delays of the gate line or the data line on various regions of the panel. Hence, the problems of the crosstalk and brightness change caused by the various central levels are solved.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a driving circuit diagram illustrating a liquid crystal display (LCD) panel in the prior art;

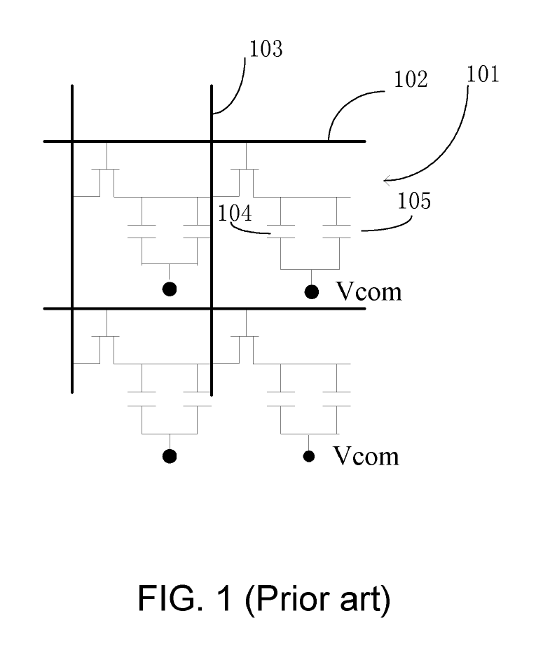

FIG. 2 is a schematic drawing illustrating a waveform of a driving signal in the prior art;

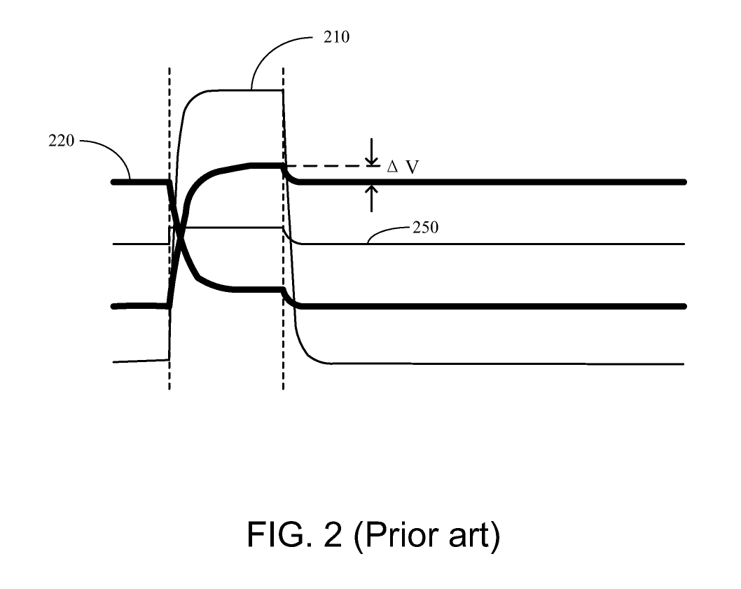

FIG. 3 is a schematic drawing illustrating waveforms of the gate voltage respectively at right and left sides of the LCD panel;

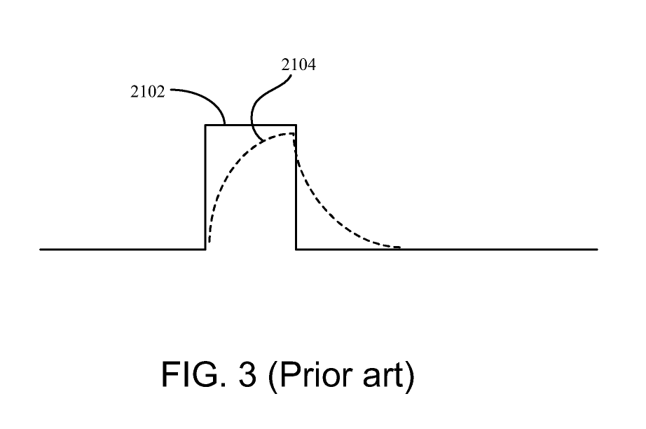

FIG. 4 is a schematic drawing illustrating an LCD panel according to one preferred embodiment of the present invention;

FIG. 5 is a top view illustrating a pixel unit according to the preferred embodiment of the present invention;

FIG. 6 is a schematic cross-sectional diagram illustrating a pixel unit according to the preferred embodiment of the present invention;

FIG. 7 is a top view illustrating a pixel unit at region B according to the first preferred embodiment;

FIG. 8 is a schematic drawing illustrating a partition of an LCD panel according to a second embodiment;

FIG. 9 is a top view illustrating a pixel unit at region C of FIG. 8; and

FIG. 10 is a top view illustrating a pixel unit at region D of FIG. 8.

### DETAILED DESCRIPTION OF THE PREFERRED EMBODIMENTS

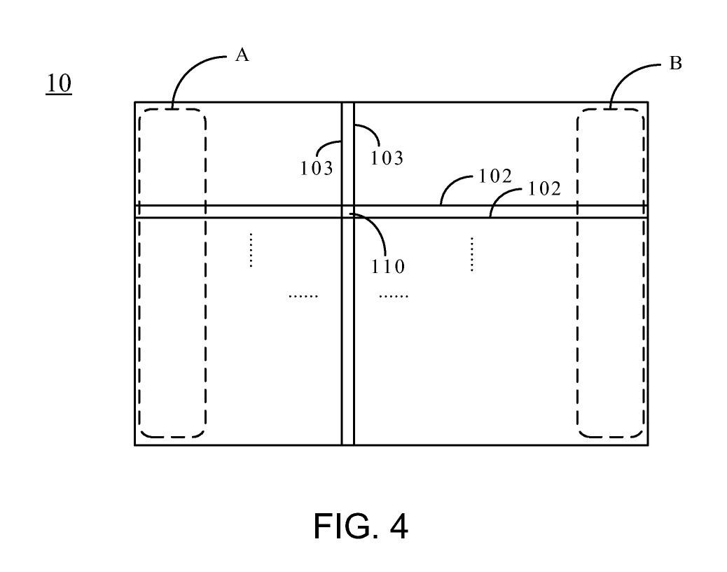

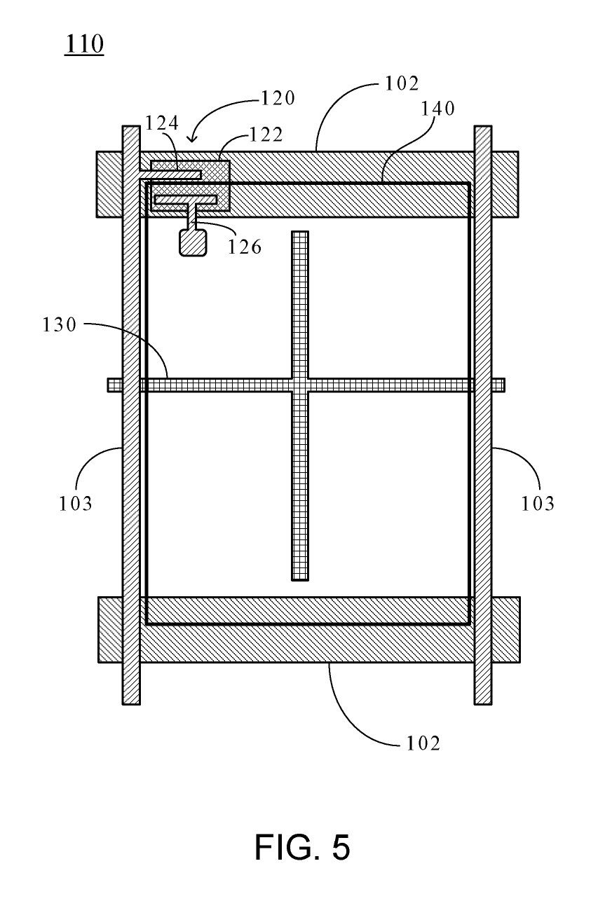

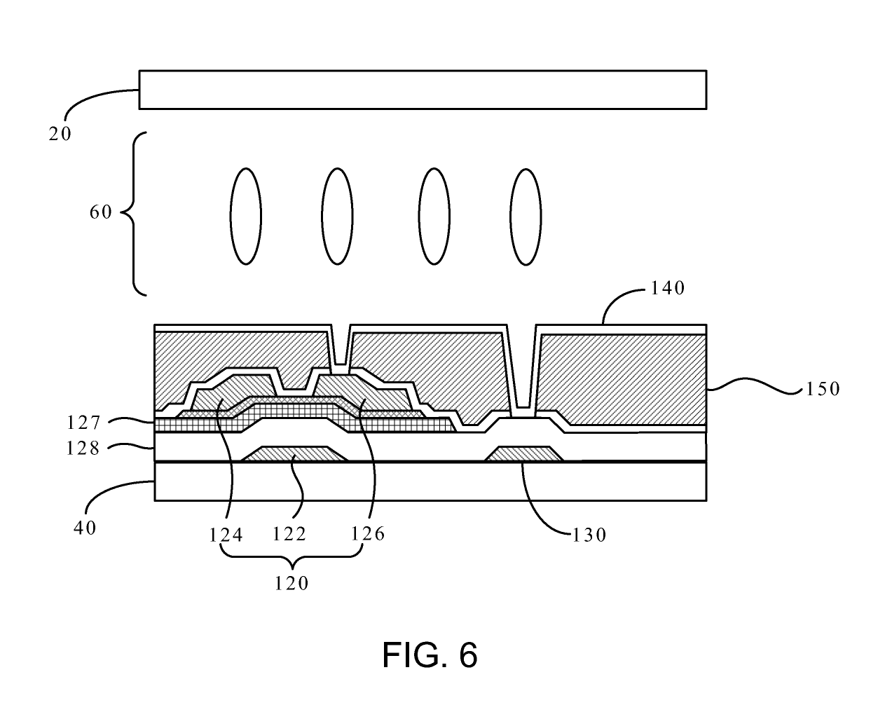

Referring to FIG. 4, FIG. 5, and FIG. 6, in which FIG. 4 is a schematic drawing illustrating an LCD panel according to one preferred embodiment of the present invention; FIG. 5 is a top view illustrating a pixel unit according to the preferred embodiment of the present invention; and FIG. 6 is a schematic cross-sectional diagram illustrating a pixel unit according to the preferred embodiment of the present invention. The LCD panel 10 of the preferred embodiment includes an upper substrate 20, a lower substrate 40, and a liquid crystal layer 60 which is located between the upper substrate 20 and the lower substrate 40, as shown in FIG. 6. The lower substrate 20 includes a plurality of gate lines 102 and a plurality of data lines 103. The gate lines 102 and the data lines 103 define a plurality of pixel units 110, as shown in FIG. 4.

Referring to FIG. 5 and FIG. 6, each pixel unit 110 includes a thin film transistor (TFT) 120, a storage capacitor electrode 130, and a pixel electrode 140. The TFT 120 further includes a gate 122, a source 124, and a drain 126, which are well-known for a person skilled in the art. In addition, the TFT 120 further includes semiconductor layers, insulative layers, and so on, as shown in FIG. 6.

Referring to FIG. 5 and FIG. 6, the LCD panel 10 further includes a color resist layer 150 and a plurality of pixel electrodes 140. The color resist layer 160 is disposed on the lower substrate 40 and covers the TFT 120 in each pixel unit 110. The pixel electrodes 140 are respectively disposed in the pixel units 110 and located on the color resist layer 160. Specifically, a color filter on array (COA) technology, which the color resist layer 160 is formed on the TFTs 120, is employed in the LCD panel 10 of the preferred embodiment. Preferably, a thickness of the color resist layer 160 is 3 micrometer, so the capacitor between the data line 103 and the pixel electrode 140 can be effectively reduced. Also the capacitor between the gate line 102 and the pixel electrode 140 can be reduced. In comparison with a conventional pixel structure, the pixel electrode 140 of the embodiment can extend outwards and even overlap the gate line 102 and data line 103 for increasing the aperture ratio.

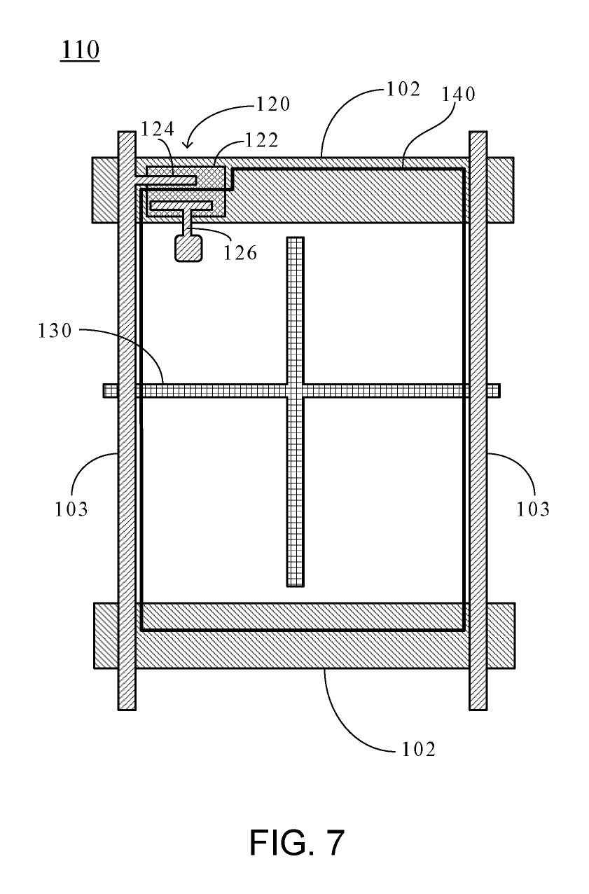

The following will explain how to compensate the differences of the feed-through voltage ΔV on various regions of the panel according to the LCD panel 10 of the present invention. Referring to FIG. 4, FIG. 5, and FIG. 7, in which FIG. 5 is a top view illustrating a pixel unit at region A according to a first preferred embodiment, and FIG. 7 is a top view illustrating a pixel unit at region B according to the first preferred embodiment. In the first embodiment, a plurality of projected areas of the pixel electrodes 140 partially overlap the gate lines 102, and the projected areas of the pixel electrodes 140 successively increase with a direction, thereby compensating the feed-through voltage ΔV differences caused by the RC delays of the gate line 102.

As shown in FIG. 5, the pixel electrode 140 within region A of FIG. 4 is the same to a conventional pixel electrode, that is, the projected area of the pixel electrode 140 is the same to that of the conventional pixel electrode. That is to say, a total capacitor(Clc+Cs+Cgs)of the pixel unit 110 at region A is the same to that of the conventional pixel electrode. Thus, the feed-through voltage ΔV of the pixel unit 110 at region A being closer to a gate driver chip (not shown) is the same to the feed-through voltage ΔV of the conventional pixel unit.

As shown in FIG. 7, in order to compensate the RC delay at the end of the gate line 102, the projected area of the pixel electrode 140 at region B of FIG. 4 increases. In the embodiment, the overlapped areas of the pixel electrodes 140 overlapping the gate lines 102 successively increase with a direction. Specifically, the projected area of the pixel electrode 140 is increased, so that the gate/pixel electrode capacitor Cgs of the pixel unit 110 at region B increases. As a result, it can be seen from the formula of the feed-through voltage ΔV that the increased Cgs compensates the feed-through voltage ΔV drop caused by the decreased Vpp.

It can be seen from the foregoing that the direction of successively increasing is a direction of the gate line 102, and especially a scanning direction (from left to right) of the gate line 102, whereby the problem of the crosstalk caused by the various central levels at the right and left sides of the LCD panel 10 is compensated. It should be noted that the shape of the increased area of the pixel electrode 140 is not limited to be implement as shown in FIG. 7, and it can also be implemented as other shapes.

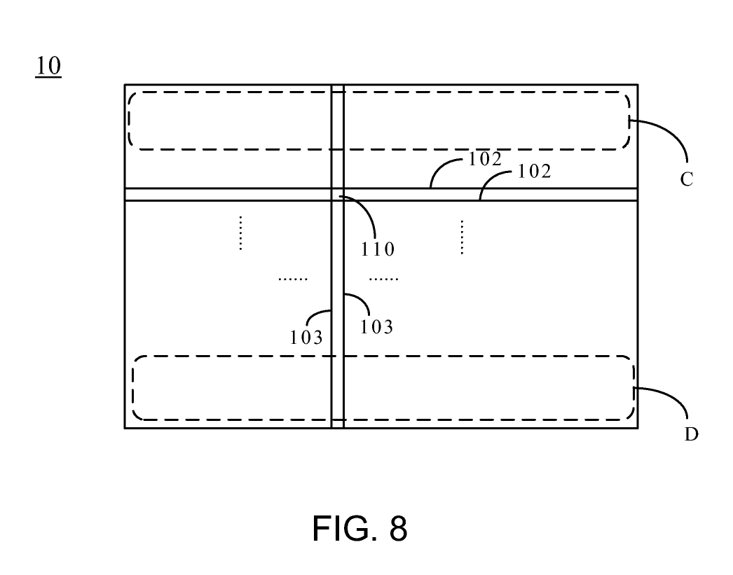

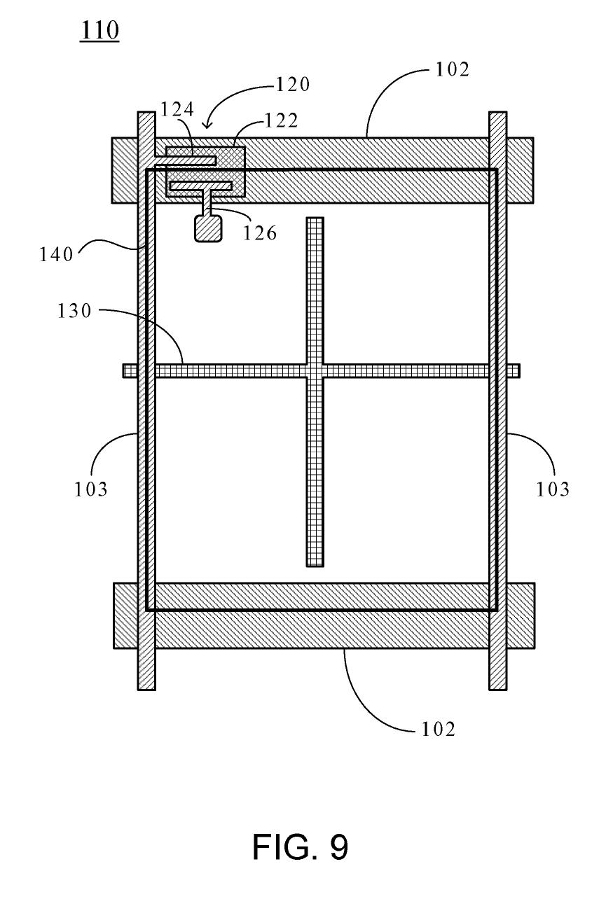

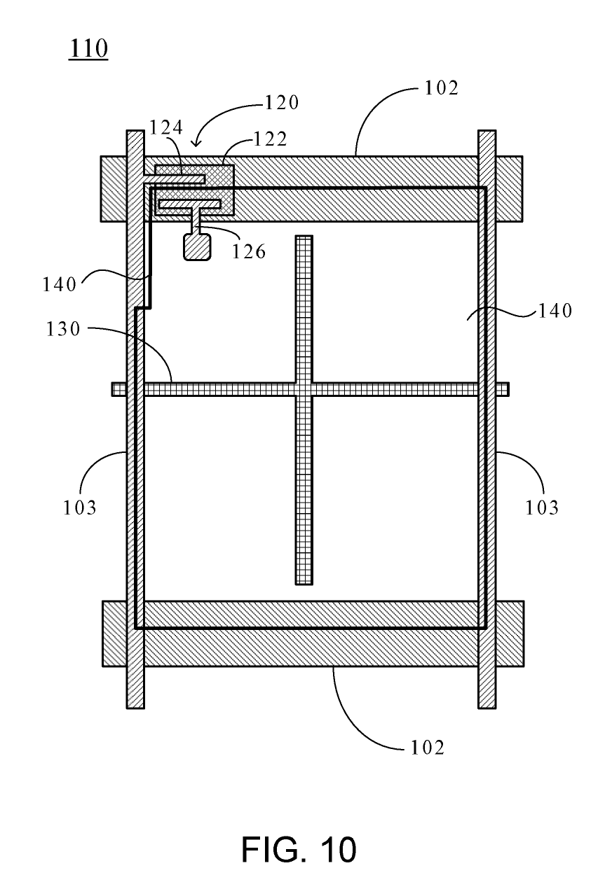

Referring to FIG. 8, FIG. 9, and FIG. 10, in which FIG. 8 is a schematic drawing illustrating a partition of an LCD panel according to a second embodiment; FIG. 9 is a top view illustrating a pixel unit at region C of FIG. 8; and FIG. 10 is a top view illustrating a pixel unit at region D of FIG. 8. In the second embodiment, the projected areas of the pixel electrodes 140 partially overlap the data lines 103, and the projected areas of the pixel electrodes 140 successively decrease with a direction, thereby compensating the crosstalk caused by the RC delays of the data line 103.

As shown in FIG. 9, the pixel electrode 140 within region C of FIG. 8 is the same to a conventional pixel electrode, that is, the projected area of the pixel electrode 140 is the same to that of the conventional pixel electrode. That is to say, a total capacitor (Clc+Cs+Cgs) of the pixel unit 110 at region C is the same to that of the conventional pixel electrode. Thus, the feed-through voltage ΔV of the pixel unit 110 at region C being closer to a source driver chip (not shown) is the same to the feed-through voltage ΔV of the conventional pixel unit.

As shown in FIG. 10. in order to compensate the RC delay at the end of the data line 103, the projected area of the pixel electrode 140 at region D of FIG. 10 decreases. In the embodiment, the overlapped areas of the pixel electrodes 140 overlapping the data lines 102 successively decrease with a direction. Specifically, the projected area of the pixel electrode 140 is decreased, so that the liquid crystal capacitor Clc of the unit 110 at region D decreases. As a result, the total capacitor of the pixel unit 110 at region D is reduced, whereby the crosstalk caused by the RC delays of the data line 103 is compensated.

It should be noted that the present invention is not limited that the projected areas of the pixel electrodes 140 can overlap only the gate lines 102 or the data lines 103, and it can simultaneously overlap the gate lines 102 and the data lines 103, as shown in FIG. 9. Moreover, the projected areas can successively decreasing or increasing with a direction, such as the scanning direction of the gate line or the transmitting direction of the data line, for compensating the differences of the feed-through voltage ΔV on the various regions of the panel.

In summary, the color resist layer 150 of the LCD panel 10 of the present invention is disposed on the lower substrate 40, so that the projected areas of the pixel electrodes 140 on the pixel unit can overlap the gate lines 102 and the data lines 103. Thus, a larger aperture ratio can be reached. In addition, the areas of the pixel electrodes of the present invention are designed to successively increase with the gate line 102 or decease with the directions of the data line 103. The successively increased areas of the pixel electrodes 140 increase the corresponding coupling capacitors, thereby compensating the differences of the feed-through voltage ΔV caused by the RC delays of the gate line 102 on various regions of the panel. Hence, the problems of the crosstalk and brightness change caused by the various central levels are solved.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An LCD panel, comprising an upper substrate, a lower substrate, and a liquid crystal layer located between the upper substrate and the lower substrate, the lower substrate comprising a plurality of gate lines and a plurality of data lines, the gate lines and the data lines defining a plurality of pixel units, each of the pixel units comprising a thin film transistor, characterized in that the LCD panel further comprises:
a color resist layer, disposed on the lower substrate and covering the thin film transistor in each pixel unit;
a plurality of pixel electrodes, respectively disposed in the pixel units and located on the color resist layer, a plurality of projected areas of the pixel electrodes partially overlapping the gate lines and the data lines, the projected areas of the pixel electrodes successively decreasing or increasing with a direction.

2. The LCD panel according to claim 1, characterized in that the overlapped areas of the pixel electrodes overlapping the gate lines successively increase with a direction.

3. The LCD panel according to claim 2, characterized in that the direction of increasing is a scanning direction of the gate line.

4. The LCD panel according to claim 1, characterized in that the overlapped areas of the pixel electrodes overlapping the data lines successively decrease with a direction.

5. The LCD panel according to claim 4, characterized in that the direction of decreasing is a transmitting direction of the data line.

6. An LCD panel, comprising an upper substrate, a lower substrate, and a liquid crystal layer located between the upper substrate and the lower substrate, the lower substrate comprising a plurality of gate lines and a plurality of data lines, the gate lines and the data lines defining a plurality of pixel units, each of the pixel units comprising a thin film transistor, characterized in that the LCD panel further comprises:
a color resist layer, disposed on the lower substrate and covering the thin film transistor in each pixel unit;
a plurality of pixel electrodes, respectively disposed in the pixel units and located on the color resist layer, a plurality of projected areas of the pixel electrodes partially overlapping the gate lines, the projected areas of the pixel electrodes successively increasing with a direction.

7. The LCD panel according to claim 6, characterized in that the direction of increasing is a direction of the gate line.

8. The LCD panel according to claim 7, characterized in that the direction of increasing is a direction of the gate line scanning.

9. The LCD panel according to claim 6, characterized in that the overlapped areas of the pixel electrodes overlapping the gate lines successively increase with a direction.

10. The LCD panel according to claim 9, characterized in that the direction of increasing is a scanning direction of the gate line.

11. An LCD panel, comprising an upper substrate, a lower substrate, and a liquid crystal layer located between the upper substrate and the lower substrate, the lower substrate comprising a plurality of gate lines and a plurality of data lines, the gate lines and the data lines defining a plurality of pixel units, each of the pixel units comprising a thin film transistor, characterized in that the LCD panel further comprises:
a color resist layer, disposed on the lower substrate and covering the thin film transistor in each pixel unit;
a plurality of pixel electrodes, respectively disposed in the pixel units and located on the color resist layer, a plurality of projected areas of the pixel electrodes partially overlapping the data lines, the projected areas of the pixel electrodes successively decreasing with a direction.

12. The LCD panel according to claim 11, characterized in that the direction of increasing is a direction of the data line.

13. The LCD panel according to claim 12, characterized in that the direction of increasing is a transmitting direction of the data line.

14. The LCD panel according to claim 11, characterized in that the overlapped areas of the pixel electrodes overlapping the data lines successively decrease with a direction.

15. The LCD panel according to claim 14, characterized in that the direction of decreasing is a transmitting direction of the data line.
